(19) United States
(12) Patent Application Publication
(10) Pub. No.: US 2011/0015968 A1
(43) Pub. Date: Jan. 20, 2011

(54) AUTOMATED MEDIA AND CONTENT REPORTING SYSTEM FOR BROADCAST MEDIA

(76) Inventor: Alan L. Carlson, Lago Vista, TX (US)

Correspondence Address: Law Office of Jack V. Musgrove;(Clear Channel Communications), 2911 Briona Wood Lane, Cedar Park, TX, 78613, US

(21) Appl. No.: 12/505,410

(22) Filed: Jul. 17, 2009

(51) Int. Cl. G06Q 30/00; G06Q 10/00; G06Q 20/00; G06Q 50/00

(52) U.S. Cl. 705/10; 705/400; 705/40; 705/34; 707/E17.108; 707/E17.045; 707/E17.102

(57) ABSTRACT

A reporting system for transmission broadcast media automatically monitors content distribution by media outlets and their delivery model, and identifies content and locates corresponding royalty arrangements and rights holders. Accordingly, royalty transactions can be minimized as superior rights holders can be directly compensated based on distribution models, private royalty agreements and statutory considerations. IN some embodiments superior rights holders such as a publisher can be compensated directly forgoing compensating intermediaries or inferior rights holders or performing rights organizations. Thus, the disclosed arrangements can calculate compensation amounts superior rights holder and a deduction amount for the compensation due to the inferior rights holder. Payment instructions for the payment amount to the superior rights holder are accordingly issued, and the payment instructions are reported to the inferior rights holder as well as the artist of a work in the content usage.

### BACKGROUND OF THE INVENTION

1. Field of the Invention

The present invention generally relates to royalty payment calculations and distribution arrangements, and more particularly to a method of tracking and analyzing broadcast content and compensating the appropriate rights holders the appropriate amount.

2. Description of the Related Art

The music industry is more complicated than most people realize. There are a host of entities providing a plethora of support functions for the artists who create the consumer demand for music. Even at the most basic level, there can be multiple artists involved in the original creation of a musical composition and its recording. For example, a lyrics writer, a musical composer, and a vocalist or other performer may work together to create a musical composition and share in the ownership of the composition. These individuals usually do not have the time, resources an possibly the business savvy to generate monetary profits from their work, so they rely on agents, publishers, labels and performing rights organizations to market their songs or videos, police usage, and obtain compensation in the form of royalty payments for their works. For example, a composer or lyricist may engage an agent who then negotiates an original contract with a publisher.

A publishing contract usually calls for ownership of rights in the work to be assigned from the artist to the publisher. The publisher then often licenses the work to a music label and collects royalties, a portion of which are paid to the artist. Some companies act as both a publisher and a label, including Sony, EMI, Universal, and Warner. Generally, performing rights organizations (PROs) such as BMI, ASCAP and SECAC act as clearinghouses to provide blanket licenses for the public performance of copyrighted musical compositions. A public performance can be a radio broadcast or the playing of music in a public venue such as a shopping mall, restaurant or bar. PROs typically calculate royalties for performances based on formulas, where the calculations are often a poor estimate of the type and amount of actual works performed. After collecting the royalty, PROs distribute a portion of the royalty to the publishers they represent according to a predefined agreement with the composers, labels and artists.

Compensation to composers and artists for their musical compositions and performances has become even more complicated with changes in the law and technological advances such as the Internet, wireless networks, handheld digital electronic devices (from mobile phones to mobile Internet audio devices and services such as those provided by the Apple Iphone®), and new audio and video player formats. Sound Exchange is a PRO that provides services for labels and/or recording artists that are similar to the service that PROs such as ASCAP, BMI and SESAC provide for the labels, composers and lyricists.

FIG. 1 diagrammatically illustrates a typical flow of royalties for various contemporary consumer outlets providing access to audio media content. Live performances by bands or disc jockeys (DJs) illustrated in block 2 typically rely on blanket licenses from PROs 16 and make periodic payments under those licenses, but such performances do not require a radio station or a band to pay record labels 40 and/or the performers 38 that performed the song and made it popular due the promotional value in receiving radio play time. In another example a recording artist or label is not compensated for a song that they recorded when a band plays this song at a bar or in a concert because the recording artist may have no rights in the music composition as played by another. Internet based broadcasters facilitating online downloads 8 and online streaming 10 make similar payments to publisher connected PROs 16, and in addition to the PRO (Sound Exchange) associated with the labels and/or artists. Internet music providers may require a middleman such as a content distribution network, an aggregator, a subscription service, an Internet service provider or a content mover who neither creates the content nor delivers the content directly to the end user or only receives payment from a subscriber. Thus, one or more of these entities may or may not owe one or more rights holders or subscription services royalties or fees. Royalty rates may also be tied to an actual or estimate number of users based on the location of the transmitter and/or on the revenue of the particular station or streaming entity or possibly just a fixed fee. It can be appreciated that determining and distributing royalty and other payments is not a straight forward and intuitive process.

Further royalty payments can change due to changes in rates and rulings made by the Copyright Royalty Board (CRB) 18 (a quasi-judicial entity created by the federal government) and such rulings might be influenced by the radio music licensing committee (RMLC) 21, and the National Association of Broadcasters (NAB) 20 which both advocate on behalf of the radio industry. Generally PROs 16 pass a portion of royalties collected (possibly based on a specific agreement) to the publisher 36 and, in some cases, directly to the composer 32 or lyricist 34. Sound Exchange 22 collects royalties associated with downloads 8 and online streaming 10 and passes a percentage of this royalty to record labels 40; and of course to performing artists 38 when they are not represented by a label 40. It can be appreciated that the sale, transmission, distribution and public performance of musical compositions is so ubiquitous that it not practical for each composer or performer to collect his or her royalties for each performance at each location. Thus, PRO's such as Sound Exchange, ASCAP, SESAC, BMI the Harry Fox Agency and others have evolved to speak with a unified voice for many rights holders, assert rights for rights holders, litigate on behalf of rights holders and operate as a clearing house or a centralized fee acquisition and distribution entity.

An intermediary, content delivery network (CDN), subscription service, aggregator or performance distribution outlet 6, can be an entity who encodes, distributes, streams and/or provides communication services such as wireless communication type services or hardwired services or a hybrid thereof. Performance distribution outlet 6 may also be required to pay one or more of the PRO's 16 and pay Sound Exchange 22 for delivering content to other entities or to end users. Satellite digital audio radio service (SADARS) 3 can include media outlets that utilize satellites to broadcast musical compositions. Sound Exchange 22 is an organization that has been designated by the Copyright Royalty Board 18 to collect and distribute digital performance royalties for recording artists or performers 38 and for sound recording copyright owners 32, 34, 36 (usually a record label 40) when their sound recordings are performed on digital cable, Internet and satellite radio. The Digital Media Association (DiMA) 24 is an industry organization that provides services to the Internet-based music industry much like the NAB 20 provides services to terrestrial broadcasters. Thus, DiMA 24 lobbies, negotiates and arbitrates royalties for the Internet-based music industry against PROs.

Payments may be made by the PROs 16, 22 to other trade organizations, for example, the National Music Publishers' Association (NMPA) the Recording Industry Association of America (RIAA), the Nashville Songwriters Association International (NSAI), and the Songwriters Guild of America (SGA) (all not shown) that represent artists in political matters. Process and related payments made by digital content movers to Sound Exchange are defined by 17 U.S.C. §114, as illustrated by block 23.

Performers 38 and labels 40 are often referred to as sound recording copyright owners (SRCOs). For an entity 12 to lawfully copy music onto a tangible medium such as a compact disk (CD) and sell the tangible medium, the entity 12 has to get a mechanical license either directly from the label 40, (or from the performer 38 particularly when the performer is independent), or from an agency such as the Harry Fox Agency 30 who is a PRO that acts as a clearing house for the labels 40 mechanical rights. The right to this license is compulsory after a notices of intention to obtain a compulsory license for making and distributing media is made pursuant to subject to the compulsory licensing provisions of 17 U.S.C. §115 of the Copyright Act dictating that royalties are sent to the publishers 36 and record labels 40.

Copyright owners such as performers 38, record labels 40, publishers 36 etc. may receive separate remuneration from the sale of tangible media by entity 12 who is a “non-title-owner” of at least one part of the rights to the musical composition. In addition copyright owners such as performers 38, record labels 40, publishers 36 etc., may receive separate remuneration from the sale of mechanical players 14, where it is anticipated that the players will be utilized to copy the artist's works.

In order to ensure the proper payments for content usage, many entities (particularly PROs) monitor radio and television transmissions and sample the broadcast content to determine statistically how many songs in their repertoires have been/are being broadcast. Early monitoring attempts relied on manual systems which were expensive and prone to error, and a variety of technologies have accordingly arisen to assist in this endeavor. Several of these approaches are discussed in U.S. Pat. No. 5,437,050, including a watermark or footprint code embedded in the song which may be electronically detected, or more complicated detection techniques which analyze multi-frequency amplitude patterns. A performance distribution outlet 6 can also be an ad agency that may require a synchronization license to use move audio clips or other audio clips when the agency creates advertisements.

The electronic monitoring system can recognize a song by matching the received pattern with a code in a reference library or database which provides a unique song identification number (ID). This approach is also used in U.S. Pat. No. 7,486,799 which then determines the owners of the content and notifies the owners of this use of their audio or images on the Internet. U.S. Patent Publication No. 2008/0201140 notes that there have numerous attempts to assign unique IDs to songs, including the ISRC (International Standard Recording Code), the ISWC (International Standard Work Code), the EAN (European Article Number), the UPC (Universal Product Code), ISMN (International Standard Music Number) and the CAE (Compositeur, Auteur, Editeur). All of these standards rely on alphanumeric codes that are either attached to physical copies of the sound recording, or embedded in the digital copy. Songs may also be identified using speech-recognition software and then matching detected words to song lyrics.

Not surprisingly, audio media outlets often pay more than they might otherwise because of the involvement of so many different entities in the payment of royalties for so many rights split among so many owners. For example, a band or radio station 2 or talk show, may only play certain types of music or even be limited to certain artists not in a specific PRO's repertoires, but they are still required to pay the middle-men like the PROs for blanket licenses. Large outlets such as radio station chains also pay increased costs due to the use of generic formulas based on an average number of songs played in 24 hours, etc. These increased costs for audio media content are inevitably passed on to the consumers. It would, therefore, be desirable to devise improved arrangements for tracking transmitted media which could allow a media outlet to more efficiently compensate rights holders and could eliminate or reduce redundant payments or underpayments for royalties. It would also be desirable if the arrangements could rely on exact content usage (play time) instead of basing royalty payments on, statistics, generic formulas or blanket licenses.

### SUMMARY OF THE INVENTION

The present disclosure provides arrangements for monitoring content distribution, automatically compile data associated with the content distribution and managing royalty payments or other compensation to content rights holders for usage of their content.

The present disclosure also provides arrangements that allow for a content distributor to automate payments to superior rights holders such as publishers and record labels while reducing or eliminating payments to intermediaries such as performing rights organizations and others by compiling data associated with the content from multiple sources using rules and administrating payments according to the data.

In yet another arrangement, payment to superior rights holders can be automated in response to monitoring of audio transmissions or “content usage” at multiple audio media outlets when specific musical compositions and the corresponding rights holders are identified. The identity of the content can be utilized to locate data and the located data can be cross-reference with one or more databases to identify or determine the rights holders and compensation relationships between the distributed content and the rights holders. In addition, payment terms and an amount of compensation can be determined and payments can be automated.

The foregoing arrangements can be achieved utilizing a method of managing a compensation system for rights holders in musical compositions that are transmitted. In some arrangements content transmission data can be monitored at one or more locations on a content distribution network. For example, monitoring can take place at a server that resides miles away from a radio station, at the radio station transmitter or at a radio receiver miles from a transmission tower. The disclosed arrangements can be a computer-implemented method that collects and manages data related to broadcasted content to determine monetary compensation for rights holders. The monitor can monitor electronic transmissions where the transmissions have a plurality of musical compositions to identify and accumulate content data. Thus, if a composition has been previously played and its associated data identified, then when the composition is played again the previously located data can again be utilized. Thus, the system can over time build a comprehensive database and operate efficiently by avoiding a comprehensive search for the majority of composition that have been broadcast or are being broadcast.

Accordingly, each suite/set of associated data that has been located for a particular composition can be stored in a database and can be verified as current and payment arrangements can be made without an extensive search for associated data required to make payment arrangements. The arrangements disclosed can generate a unique identifier for each musical composition and can associate the unique identifier with rights holders and payment conditions.

In some arrangements, using the identifier, third party database access information and rules, or more relational databases can be searched in an effort to locate information related to or associated with the musical composition. Such associated information can include the identity of multiple rights holder in the musical composition and define specific rights, such as a compensation arrangement for each right holders or a hierarchy of rights holders. The disclosed arrangements can also associate the broadcast content with a type of transmission system, content delivery system, distribution system, or business model and calculate amounts due to the rights holders. Some business model arrangements disclosed herein can automatically track revenue of media outlets and calculate payments due to rights holders based on the revenue of the outlet that distributed the content, or alternately based on a particular possibly nonstandard royalty agreement/arrangement.

The type of transmission systems or business models can be streaming, terrestrial broadcasting, HD radio transmissions, cell data network communications, satellite communications, MP3 protocols, shoutcast protocols, content distribution methodologies, monetization models, intermediate transmission services, transmission relay services, and repeater services to name a few. Accordingly, a content distribution model can be determined and a rights holder compensation arrangement can executed based on how content is distributed and to whom it is distributed.

In some embodiments, a compensation amount to be paid by more than one content handler in a content distribution system to each right holder can be based on content distribution data and royalty arrangements between the parties or legislated mandates. The compensation amounts can be accumulated for each right holder based on the plurality of musical compositions transmitted over a period of time or an accounting interval and an invoice or report can be generated for each content mover and rights holder such that each party can ensure an accurate accounting.

Rights holders can include composers, lyricists, publishers, performing artists studio artists, record labels, promotional/marketing organizations, promoters, and performing rights organizations or collections organizations such as BMI, ASCAP, Sound Exchange, SESAC, the Harry Fox agency etc., and any investors thereof. When a content mover has a direct license with one or more of the rights holder, the disclosed arrangement allows for a content mover or consumer to bypass middlemen or collection entities such as BMI ASCAP, Sound Exchange etc. Bypassing or carving out the middleman allows a media outlet to pay the superior rights holder such as the publisher or label or even the songwriter or performing artist directly, reducing the number of transactions thereby making the copyright royalty calculation and payment system much more efficient. A composer or performing artist that is not represented by a “middleman” or has not assigned rights or does not have a contract with a publisher or a label is often referred to as an independent artist. The disclosed arrangements can determine if the composition for which royalties are due has an independent or unrepresented owner and can automate compensation directly to the rights owner. This can significantly reduce the amount due by a content mover because the over head required by the performing rights organization can be saved. It can be appreciated that even though the amount paid by the provider is less the superior rights holder (i.e. the artist that produced the composition) can receive significantly more compensation that he or she would because of the elimination of the middleman.

The artists and composers or originators of the musical compositions can be referred to as superior rights holders for payments based on content usage and accordingly, direct payment to the superior rights holders can reduce or eliminate compensation currently absorbed by the middleman. The disclosed arrangements can calculate compensation due to the superior rights holder for content usages, tag the content as having a paid in full royalty and forgo the royalty payment or payment calculations for the PRO or middleman, thereby carving out the middleman payment such that the royalty is not paid twice.

In some embodiments, instead of a total royalty carve out, a partial royalty carve may be calculated based on an agreement or a legal precedence. Thus, in some embodiments calculations for the amount due the middleman may reduce an amount due by deducting the compensation due to the middleman (a carve out) based on the amount paid to one or more rights holder such as the superior rights holder. Payment instructions can be executed where a content mover's account is debited and a rights holder's account is credited and this feature can significantly increase the efficiency of the compensation system.

The payment calculations and actual payments can be reported to the middleman as well as other rights holders such that a rights holder can see how royalties were calculated and paid to various rights holders. Many PROs have royalties that are collected, however, not distributed to rights holders possibly because the artist cannot be located. Proper management of these unclaimed royalties can provide further improve inefficiencies in the royalty compensation system.

The associated data can include a title of a show, composition or work, a composer, a performer, a representative of the composer and/or performer, the number of times that the work has been played within an accounting interval, content distribution data associated with each play, estimated listener data etc.

In some embodiments the monitor can include a receiver which records data regarding what musical compositions will be, are being, or have been transmitted and can automatically match the recorded data to baseline data to provide a unique identity for the musical composition. In addition the monitor can provide a unique identifier for a specific distribution system or media outlet, a specific time the content was received by an end user and any peculiarities of the end user such as details associated with a subscriber plan. The distribution system could be for example a portal or a terrestrial broadcast station, an aggregator, a streamer, a communications service provider, a subscription service or a satellite based radio station to name a few.

Some arrangements include searching a plurality of databases for metadata associated with the transmitted musical composition and adding data, possibly data defining different attributes of the musical composition such as royalty arrangements for multiple rights holders. In some embodiments the musical composition identifier is determined utilizing a unified numbering system database which can assign a unique identification number to the detected musical composition. The above novel arrangements and features of the present disclosure will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a chart illustrating the conventional flow of royalties and other payments for audio content usage to various rights holders and performing rights organizations;

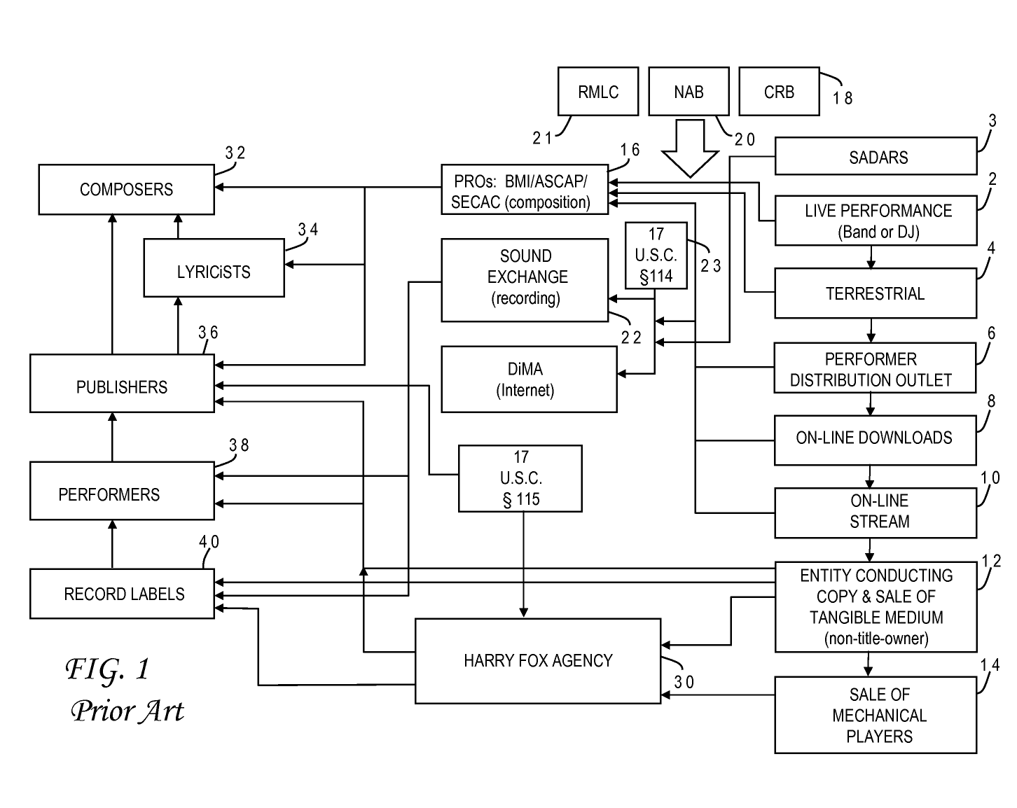

FIG. 2 is a block diagram of a computer system programmed to carry out content usage analysis and payment reporting;

FIG. 3 is a block diagram for an exemplary implementation of the present invention illustrating various entities, audio media outlets, functional workstations, and databases which are interconnected via the Internet;

FIG. 4 is a chart illustrating various relationships, arrangements, agreements and laws that are taken into consideration when determining compensation amounts due to different rights holders for a particular media broadcast; and

FIG. 5 is a chart illustrating the logical flow for determining compensation of various rights holders for various utilizations of their works by multiple entities.

The use of the same reference symbols in different drawings indicates similar or identical items.

### DESCRIPTION OF THE PREFERRED EMBODIMENT(S)

After understanding the background section above, it can be appreciated that managing copyright royalties is a complex convoluted process for copyright owners, rights holders and users of copyrighted materials. For one, the ownership and management of exploited music copyrights through multiple licenses and multiple entities includes calculations and collection strategies for the resulting type of use and royalty and fee arrangement. Types of use can include, copying the composition onto a tangible media which results in mechanical royalties, performing the work can include song writer performance royalties and allowing works to be used in part can result in synchronization fees and different entities may own the rights to each of these royalties. Thus, rights are often very fragmented and administrating the use of a copyright throughout the United States is a complex and convoluted process. The business of music publishing, performance and promotion is littered with obscure, misleading, and archaic terms such as ephemeral rights, some of which have more than one meaning depending on the context. Some of the permission processes and royalty considerations are confusing if not downright intimidating and ubiquities use of one's copyrighted materials merely compounds the management and accounting problems. It would be beneficial to have an automated system for at least a portion of this complex process.

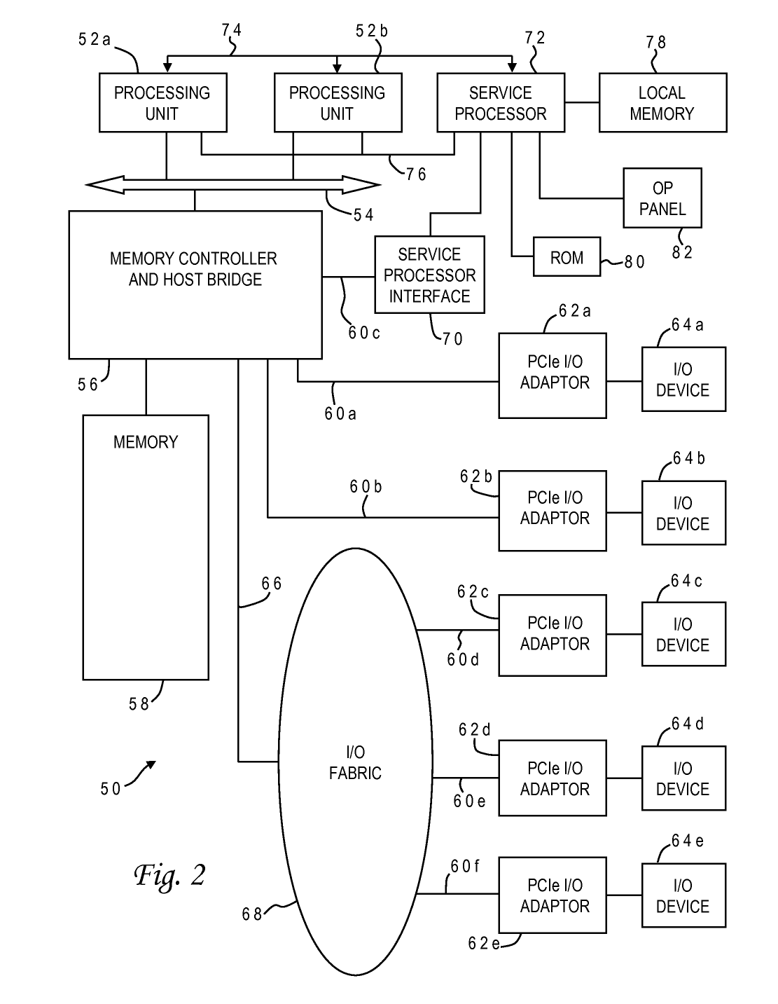

With reference now to the figures, and in particular with reference to FIG. 2, a computer system 50 is depicted which could be utilized to carry out broadcast media analysis and payment reporting. Computer system 50 is represented as a symmetric multiprocessor (SMP) system having a plurality of processors 52a, 52b connected to a system bus 54. System bus 54 is further connected to a combined memory controller/host bridge (MC/HB) 56 which provides an interface to system memory 58. System memory 58 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 56 also has an interface to peripheral component interconnect (PCI) Express links 60a, 60b, and 60c. Each PCI Express (PCIe) link 60a, 60b is connected to a respective PCIe adaptor 62a, 62b, and each PCIe adaptor 62a, 62b is connected to a respective input/output (I/O) device 64a, 64b. MC/HB 56 may additionally have an interface to an I/O bus 66 which is connected to a switch (I/O fabric) 68. Switch 68 provides a fan-out for the I/O bus to a plurality of PCI links 60d, 60e, and 60f. These PCI links are connected to more PCIe adaptors 62c, 62d, 62e which in turn support more I/O devices 64c, 64d, and 64e. The I/O devices may include, without limitation, a keyboard, a graphical pointing device (mouse), a microphone, a display device, speakers, a permanent storage device (hard disk drive) or an array of such storage devices, an optical disk drive, and a network card for connection to a local area network (LAN) or the Internet. Each PCIe adaptor provides an interface between the PCI link and the respective I/O device. MC/HB 56 provides a low latency path through which processors 52a, 52b may access PCI devices mapped anywhere within bus memory or I/O address spaces. MC/HB 56 further provides a high bandwidth path to allow the PCI devices to access memory 58. Switch 68 may provide peer-to-peer communications between different endpoints and these communications do not need to be forwarded to MC/HB 56 when cache-coherent memory transfers are not required. Switch 68 is illustrated as a separate logical component but it could be integrated into MC/HB 56 or other components.

In the illustration, PCI link 60c connects MC/HB 56 to a service processor interface 70 to allow communications between I/O device 64a and a service processor 72. Service processor 72 is connected to processors 52a, 52b via a JTAG interface 74, and uses an attention line 76 which can interrupt the operation of processors 52a, 52b. Service processor 72 may have its own local memory 78, and is connected to read-only memory (ROM) 80 which can store various program instructions for utilization during a system startup mode. Service processor 72 may also have access to a hardware operator panel 82 to facilitate the acquisition and display of system status and diagnostic information.

In alternative embodiments computer system 50 may include modifications of these hardware components or their interconnections, or additional components. Accordingly, the depicted example should not be construed as implying any architectural limitations with respect to the present disclosure.

When computer system 50 is initially powered up, service processor 72 can utilize a JTAG or IEEE compatible interface 74 to interrogate the system (host) processors 52a, 52b and MC/HB 56. After completing the interrogation, service processor 72 can acquire an inventory and topology defining the attributes of the computer system 50. Service processor 72 can execute various tests such as built-in-self-tests (BISTs), basic assurance tests (BATs), and memory tests on the components of computer system 50. Any error information for failures detected during the testing can be reported by service processor 72 to operator panel 82. If a valid configuration of system resources is still possible after taking out any components found to be faulty during the testing then, computer system 50 can proceed to execute processes.

Executable code can be loaded into memory 58 and service processor 72 can activate host processors 52a, 52b for execution of the program code, e.g., operating system (OS) code which can be used to launch applications and in particular the disclosed automated reporting application, results of which may be stored in a hard disk drive of the system (an I/O device 64). Computational results may include identify of distribution networks, identity of content, titles, rights holders, payment arrangements, payment and deduction amounts and content usage data, as explained further below. While host processors 52a, 52b are executing program code, service processor 72 may enter a mode of monitoring and reporting any operating parameters or errors, such as the cooling fan speed and operation, thermal sensors, power supply regulators, and recoverable and non-recoverable errors reported by any of processors 52a, 52b, memory 58, and MC/HB 56. Service processor 72 may take further action based on the type of errors or defined thresholds.

While the disclosed implementation can have program instructions embodying the present invention on disk drive 76, those skilled in the art will appreciate that the disclosed arrangements can be embodied in a program product utilizing other tangible computer-readable media. In addition the program instructions may be written in the C++ programming language for a Windows® environment or in other programming languages suitable for other operating system platforms. Computer system 50 can carry out program instructions for a payment reporting system that tracks content usage in broadcast media, locates royalty arrangements and makes payment allocations to rights holders. Accordingly, a program embodying the disclosed arrangements may include conventional and non-conventional aspects of various media monitoring technologies, and these details will become apparent to those skilled in the art upon reference to this disclosure.

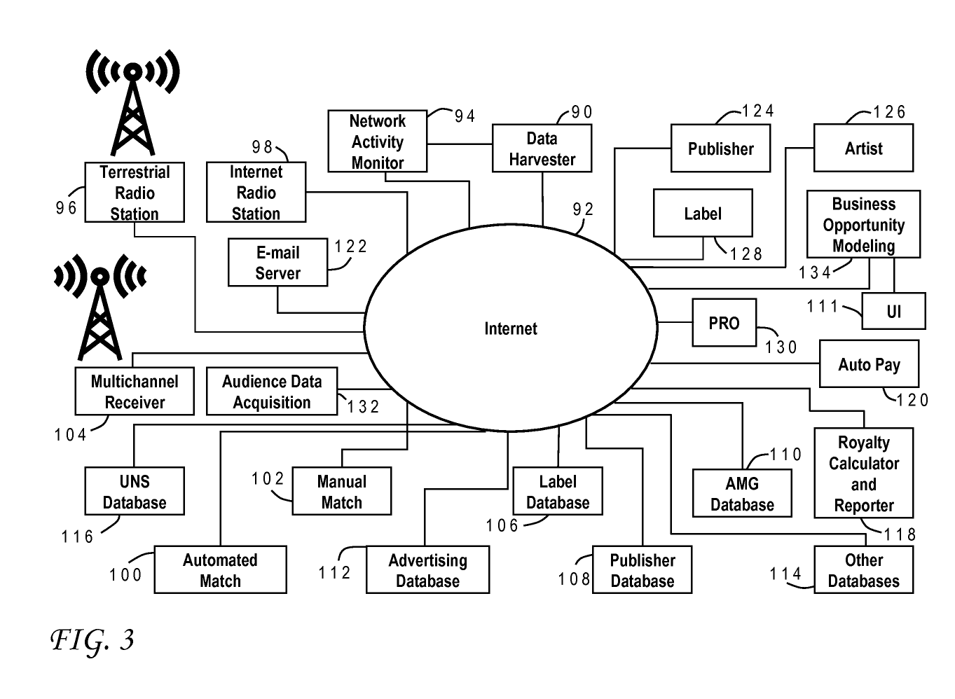

With further reference to FIG. 3, the computer system 50 of FIG. 2 may operate as a workstation and carry out any one of a number of functions relating to analysis of broadcast media, calculation of royalties or other payments, and payment allocation and reporting. In particular, computer system 50 may act as a data harvester 90 to track media content usage. Data harvester 90, as well as most of, if not all of the components depicted can be connected to the Internet 92 to allow for communications with, and between the various other network nodes described below. Data harvester 90 can receive many types of data from many types of databases, can organize and store the data and can create and store metadata on the harvested data. For example, the data harvester 90 can access or received data from a plurality of monitoring entities that monitor content (either directly or indirectly) that will be, has been or is being made available to an end user or listener. Such monitoring entities can be placed at terrestrial radio station 96, internet radio station receiver 98, or any component in a distribution chain of a media outlet. In some embodiments, data harvester 90 can receive content usage data and metadata and data associated with the content or can search for such data using a network activity monitor 94, terrestrial radio station 96, internet radio station 98, matching services 100, 102, music label databases 106, publisher databases 108, AMG data base 110 etc.

Network activity monitor 94 can provide internet-based (e.g., website) sales data and point-of-sale data for sales to data harvester 90 via Internet 92. Network activity monitor 94 can provide data that tracks consumer actions such as browsing, Internet purchases or just user activities when a user reviews and selects content from a variety of audio or multimedia products. A user may select or review songs or music videos or download content for use with a local computers or portable devices, or may stream content or download pod casts, and then may pay for such activities on a per-use basis or as part of a periodic subscription fee. Network activity monitor 94 can provide data harvester 90 user activity and content usage data and associated data such how many of each song is sold or downloaded and the data associated with the transaction such as the title of the musical composition and the rights holders associated with the composition and the monetary distribution arrangement between the parties.

Terrestrial radio station 96 can broadcast music or other audio content over the air waves and a multichannel receiver 104 can receive the content and identify the content by accessing various data bases in the system. The terrestrial radio station can have automated systems such as a traffic and billing system and a playlist generator that generates a playlist. In some embodiments each time a song is queued for transmission, data indicating the title of the content and data associated with the title can be sent to data harvester 90 such that each song that is broadcast is accounted for. This accounting can be performed for each media outlet. Internet radio station 98 can also have an automated playlist and operate in a manner that is similar to a terrestrial radio station 96, but provides webcasts and podcasts instead of over the air broadcasts. Data harvester 90 can receive data from internet radio station 98, can monitor or sniff the transmission and can acquire content distribution data may include the number of listeners connected at the time a given song is distributed. Data harvester 90 can also acquire or monitor attributes of one or more of the components of distribution channel being utilized to distribute the content. Distribution channel data can be used to determined what rights holders should be compensated. For example, Sound Exchange needs to be compensated for Internet distribution of content to end users while Sound Exchange does not need compensated for distribution via the terrestrial broadcast. Distribution channel data can also include detecting the number of listeners or computers that are connected to given stream at a given time, or how many listeners are receiving a particular song. Such data can be acquired via various methods, such as a log-based analysis or a snapshot or a sampling-based analysis. With log-based analysis, the streaming of the broadcast is conducted via a content delivery network (CDN) which can be operated by an internet service provider or a content distribution network which can be a subcontractor of a content distributor or a broadcaster.

The log data collected by the CDN can be data associated with the title of the content such as start time, length of continuous play, stop time and identification of a content distributor and a broadcast/media outlet. Title data and associated data can be utilized to capture listener data such as the number of listeners connected. With snapshot-based analysis, the CDN can summarize the total number of listeners for each station at periodic time intervals, such as every 5 minutes. In some embodiments CDN sampling data can be used in coordination with the playlist data to acquire audience measurement and audience engagement and thereby approximate the number of content performances heard by a quantity of listeners/end users. Although not shown, a satellite radio station can be configured to distribute content to end users and to provide similar content distribution information.

Multichannel receiver 104 can record audio data from a variety sources, including radio (air-wave), web or satellite broadcasts that do not provide their own direct monitoring, or can receive and record localized usages such as a concert, bar, elevator or other music venue. Receiver can utilize many different technologies such as watermarking to identify a title of content that it receives. Multichannel receiver 104 can record or acquire audio data and interface with automated matching database 100 to acquire a unique identifier for the content exploited. If multichannel receiver 104 cannot automatically match the content to a title a recording of the content can be sent to manual match service 102 where humans can identify the content and provide the content with a unique identifier. Automated matcher 100 can accept a portion of the content that has been broadcasted and can utilize complex sampling, voice recognition, watermarking, tone recognition, and other sophisticated computer algorithms to identify the content and provide a unique identifier and a playtime associated with the exploited content to data harvester 90.

Automated matching system 100 can employ artificial intelligence and can progress through a succession of multiple algorithms in an attempt to find a matching technology that uniquely identifies the content to a predetermined degree of certainty. In some embodiments commercials and commercials that include songs can be identified by title, artist or other indicia without human involvement. These algorithms may include those described in the Background section, such as detection of an embedded code, multi-frequency amplitude analysis, or a speech-to-text tool with lyric matching.

If automated matching system 100 is able to identify the song or content, a unique identifier can be assigned and the identifier and associated data can be the transmitted to data harvester 90. The associated data can include a time stamp representing the approximate time the content was broadcasted or exposed to the public or an end user. If automated matching 100 is unable to identify the content it can forward the data to manual matching system 102 where individuals can identify the content or assign a new number to the content. If one of these individuals recognizes the song, she can manually enter the unique identifier and data associated with the content or unique identifier (title of song, artist, etc.) into a form and the entry can be transmitted to data harvester 90.

The data harvester 90 can have a data template with multiple data fields, such as title, unique identifiers, rights holder, compensation arrangement, payment arrangements, distribution model, distribution attributes etc. After receiving a unique composition identifier, data harvester 90 can locate empty data fields and automatically search data sources via the Internet and can gather data that is associated with the unique identifier. Other data bases 114 may contain a cross reference list as a radio station may have a unique identifier for a particular song and AMG 110 the publisher 108 the label 106 and the UNS database may have a different unique identifier and a cross reference can allow the data harvester to retrieve data from various data bases using pointers that point to the data base likely to have the data and the cross reference data that is likely valid for a particular database.

Once enough data fields are known, or filled in the data harvester 90, royalty calculations, royalty allocations, payment reporting, and actual monetary distributions such as wire transfers can be facilitated. In some embodiments data harvester 90 can periodically queries multiple remote databases, (often during non peak times) among them a label database 106, a publisher database 108, an AMG database 110, and advertising database 112, and other databases 114, and create and store a mirrored data base locally to reduce transactions during peak usage periods. In fact the data harvester 90 may only update is mirror data based as data is modified in the “master” databases such as the publishers labels and AMG databases 106 108 and 110.

There are many recording labels and label database 106 represents multiple databases where each data base can be updated and maintained by a particular label. This database can be a relational database that associates a content /song identifier with a title and one or more rights holders. For example, a song title may be associated with a composer, a lyricist, an artist, a creditor, and multiple PROS such as ASCAP and Sound Exchange. The identifier can also be associated with a royalty arrangement that links a distribution system such as the internet to a per play amount to a label, a percent of revenue to a PRO or a label to an artist, a percentage for PRO and song writer etc. It can be appreciated that royalty arrangement and agreements can be very complex often based on distribution methodology, monetization models such as subscription services, collection amounts, minimums, maximums, percentages, cutoffs, incentives, bonuses, net revenue clauses, pass-through clauses, attachments, etc and such arrangements can be stored in one or more of the data bases illustrated and this data can be harvested by the data harvester.

Generally label database 106 can provide correlation information regarding song titles, artists (composers and lyricists), and publishers. Likewise, publisher database 108 represents multiple data bases created and maintained by a various publishers, and can provide data regarding songs owned or licensed by a particular label. Publisher database 108 can also provide for correlation regarding songs including the titles, artists, royalty arrangements and labels. AMG (All Media Guide) database 110 can also contain metadata about songs, movies, video games, audio books, and music releases and ownership thereof. Advertising database 112 can contain information about media (e.g., songs) used in commercials or other advertising content and can contain pure ads where the system can calculate royalties for rights holders in non musical advertising content. Other databases 114 also illustrated databases created and maintained by performing rights organization (PRO) databases, or databases operated by private companies such as Gracenote (owned by Sony Corporation) that can relate titles to rights holders and can provide at least insight to compensation arrangements where royalty calculator and reporter 118 can assume a royalty compensation arrangement based on the information that can be gathered by data harvester 90. It can be appreciated that most if not all PROs maintain a database containing songs and the associated labels, artists and publishers etc that own rights in the song that the PRO represents.

Data harvester 90 can resolve media content data conflicts using rules or a decision hierarchy, for example, if a label database 106 indicates a particular song is owned by one publisher but a different publisher has a database indicating that it owns the song, then the publisher database will be trusted over the label database for the publisher data. The metadata harvested can include one or more identification numbers unique to a song or content and such identifiers can be created and utilized according to various standards, industry organizations or private, possibly proprietary inventorying arrangements. In some embodiments data harvester 90 can facilitate the creation, maintenance and usage of unified numbering system (UNS) database 116 as data harvester 90 conducts relentless searches of internet accessible or local network accessible databases using search rules, artificial intelligence and other search criteria to locate acquire, compile, correlated, coordinate, collate, collaborate organize and store data related to content distribution. UNS database 116 can be embodied as a relational database that includes these various identification numbers and associated data. When new content is detected the UNS database can assign a new unique identification number and locate associated unique identifiers and associated data such as rights holder data and compensation arrangements.

It can be appreciated that discrete content such as a single song may comprise multiple works and multiple rights holders. For example, when one melody or composition is recorded or performed by different artists, the title may appear with more than one unique identification number. However, a data base like the other database 114 may maintain a list of many different artists that are associated with a particular publication, song or composition. Thus, when data harvester 90 receives broadcast media content data from monitoring services 94, 96, 98, 100, 102, using a “best practice” can first query UNS database 116, and if UNS database 116 has the desired data or at least a significant portion of the desired data then the data harvester can identify what desired data is missing and based on the acquired data and the missing data, the data harvester can determine a secondary search that will likely provide the best search results. Such a process can continue until the desired data is located and if data is missing assumptions can be made and tagged as such. Thus, if the first search of the UNS database provides the desired data the search can end as it may be unnecessary to query the remaining databases.

Data harvester 90 can compile data retrieved from and provided by the content distribution monitors over a predetermined period of time, such as 24 hours or a week, and can automatically forward data utilized to calculate and distribute royalties based on the private party arrangements, statutory rates and content exploitation to the royalty calculator and reporter 118. The usage, distribution, exploitation information can be utilized by the royalty calculator and reporter 118 to provide e-mails to the rights holders due compensation such as the publisher 124, label 120 and pros 130 and auto pay system 120 can electronically make payments to these rights holders.

In some embodiment royalty calculator and reporter 118 can be pre-programmed with information provided by the rights holders regarding royalty fees that may be due to various rights holders (e.g., artists, publishers, labels, sound recording copyright owners, or PROs) based on existing business arrangements between the rights holders and the broadcasters, or compulsory licensing schemes. In other embodiments the royalty arrangements can be located and retrieved from one or more databases having the royalty arrangements for an applicable license. It can be appreciated that current compensation process over compensate some rights holders an under-compensate other rights holders due to many factors such as the lack of accounting, inaccurate accounting due to statistical assumptions and poor records management.

The present arrangement allows royalty calculator and reporter 118 to track and utilize statutory royalty rates, standard royalty arrangements, private agreement royalty rates/arrangements and other royalty distribution information in a separate database which can index rights holders and any associated royalty rates and fees due based on the unique identification numbers assigned to the content. When no private agreement is located, the calculation can resort to a standard royalty arrangement or a non standard arrangement possibly based on the preference of a label or a PRO.

For example, a standard arrangement may include determining a number of distributions of specific content and using a unique content identifier to locate the PRO that has the content in its catalog or repertoire. Using the distribution data, such as Internet download subscription service or a simulcaster, the royalty calculator 118 can access the statutory rate and determine that Sound Exchange is due a per-play royalty and that the located PRO is due specific amount based on a blanket license. The process may end here, however if a royalty arrangement can be located or assumed between the content distributor, the PRO and the other rights holders then the royalty calculator 118 can further distill/distribute the royalty payment.

For example, if the content distributor such as a terrestrial radio station has a direct license with a label or an artist that station can pay the label or artist directly eliminating the administrative fee charged by the PRO. In addition the royalty calculator 118 can further distribute the blanket license fee mention above by paying a percentage of the blanket fee to the lyricist, to the composer, to the publisher and to the PRO based on a standard industry royalty agreement sometimes set by a union. It can be appreciated that the current system are far from perfect when it comes to royalty distributions. For example, at the end of the year the PROs, the labels and the publishers often have a windfall as many rights holders can't be located due to deaths, incapacitation and outdated contact information. Another imperfection is that PROs, labels and publishers add sometimes unnecessary levels of management to the business model as they tend to be bureaucratic and inefficient and ad significant overhead costs. If an artists, a composer or a lyricist was directly compensated by a content distributor the content distributor would pay less and the often underpaid artist would receive significantly more.

Accordingly, the disclosed arrangements can maintain contact and payment information such as e-mail addresses and bank account information electronically in the auto-pay data base 120, where interested parties can easily update such information that is important to make the disclosed compensation arrangements work more efficiently. The disclosed arrangements can also adapt to changes in royalty arrangements that often change every year for specific royalty arrangements.

Royalty calculator and reporter 118 may utilize direct license royalty terms between the content distributor and the publisher to compensate the publisher such that the content distributor does not pay the royalty twice. For example, when a content distributor, distributes a particular song to an end user, based on a direct agreement, the publisher can be compensated by either a first payment to a publisher or a second payment to a PRO, according to a royalty distribution arrangement. In such a case, the distributor's payment directly to the publisher can eliminate the need for or reduce the amount of separate compensation to the PRO.

Alternatively, if the distributor has a blanket license with a PRO then some or all of the direct payment to the publisher may be deducted from the blanket licensing fee due the PRO. By agreement, a payment to a publisher is usually less than a payment to a PRO since the PRO acts as a middle man and charges the publisher for its services to collect and distribute the royalty. If a PRO has inaccurate accounting the royalty due the publisher may not be passed on to the publisher. When such a direct agreement exists, the royalty calculator and reporter 118 can flag the publisher as a superior rights holder since that payment due the publisher is smaller and thus this payment will eliminate or reduce to the amount due to the PRO, who is flagged as an inferior rights holder. Royalty calculator and reporter 118 can optionally identify other entities such as subscription services that facilitate at least part of the electronic transmission, and determine royalty liabilities of one or more of these entities using data accessed via data harvester 90. The entities could also include unlicensed content distributor, a content provider, service providers, a content mover, intermediaries, aggregators, encoders, communications provider, entities in the chain of a subscriber based distribution system, a portal provider, or an Internet service provider.

After calculating payment amounts for compensation due to superior right holders based on media content usage, and figuring related deductions (carve-outs) from payments to inferior rights holders, royalty calculator and reporter 118 can automatically issues corresponding payment instructions and reports via auto pay system. Payment data can be sent to auto pay system 120 which can arrange for payment approvals, wire transfers, etc., to the rights holders (i.e. 124, 128, 130, 126 etc.) in accordance with the data associated with content that has been distributed to end users. More specifically, royalty reports and amounts due according to the report can be sent to the rights holders; publisher 124, artist 126, label 128, and PRO 130 via e-mail server 122 in accordance with the report and payment instructions. E-mail server 122 may also be used to deliver payment confirmations from auto pay 120. In some embodiments, audience data acquisition system 132 (e.g., listener polling) can query end users or listeners to determine the popularity of specific content or songs and e-mail server 122 can be utilized as part of the polling system to query listeners and receive communication regarding song popularity.

After it has been determined by a monitoring entity, such as multichannel receiver 104 or network activity monitor 94 that content has been distributed such that a royalty would likely be due, a unique identifier associated with the title of the content can be stored at the data harvester 90. The data harvester 90 can conduct its search for associated data using a set of assertions, which collectively can form a ‘working memory.’ In addition, the data harvester 90 can utilize a set of rules in the working memory to determine how the data harvester 90 will proceed with searches and will fill data files based on what data it has acquired and want data it needs. For example, when data can't be located at the preferred databases, using the rules, default values can be located and placed in data fields. Thus, when actual royalty arrangement can't be located in the private databases based on the rules statutory royalty rates, industry standard rates, rights holder's standard rates, or union rates can be entered into blank data fields. Utilizing the assertion set, a rule-based decision process can be utilized to acquire the desired data, and then royalty payments can be distributed to rights holders.

This rules based search embodiment can consist of a set of “if-then” statements and such a configuration can be considered an “expert system.” The concept of an expert system is that knowledge can be encoded into the rule set possibly as part of a learning routine such as those utilized in artificial intelligence. When exposed to the same data, the expert system AI will perform in a similar manner to a human expert.

In the rules based search embodiment the data harvester can have four basic components, a list of rules, which are a specific type of knowledge base, an inference engine or semantic reasoner which can infer information or takes action based on the interaction of input data and the list of rules, a temporary working memory a, user interface or other connection to the outside world through which input and output signals are received and sent.

The disclosed arrangements can provide certain adjunct features to further enhance the automated broadcast media royalty compensation system. For example, listener and consumer feedback may be obtained for a given audio stream, a terrestrial broadcast or a time period using audience data acquisition system 132. Audience data acquisition system 132 can be a third party service such as Arbitron, Neilson, or Media Monitors that provides all kinds of rating, rankings and audience data. The listener data can be data associated with polling results, audience reaction, and can further include data such as song popularity, artist popularity, and advertising and can be stored with, and associated with other content related information compiled by data harvester 90. This listener data can be associated with the content data information and listener data may be utilized by business opportunity modeling system 134 to suggest business opportunities to entities in the entertainment industry and to advertisers.

In some embodiments, business opportunity modeling system 134 can analyzes the content data and metadata from data harvester 90, as it applies to specific content and suggest profitable strategies based on listenership. For example, if a specific recording artist, via multiple songs has a large or the most overall playtime and downloads then a concert promoter or an advertiser can obtain such information and predict whether a tour by the artist would be profitable. Likewise, an advertiser may be provided with a business case where the cost of an endorsement, or a royalty arrangement from a endorsement is known or can be estimated and based on the popularity of the artist, the business modeling system 134 can provide the advertiser with information regarding how many audience reactions can be achieved with a particular artist and thus what the cost per listener impression will be, or the cost value trade off when using a particular artist in a particular way.

In some embodiments, business opportunity modeling system 134 can determine a most popular (or most lucrative) artist or song within a given time period based on weighting of factors contained in the data. For example playtime, listener feedback and the rate of increase of popularity can have different weights and can be placed into an equation to project the profitability of a proposed business plan. Business modeling system 134 can also review popularity data and determine that a composers or lyricists has written a significant number of popular sings that have been made popular by many different number of artists. When a recording artist is looking for material, the artist can use a user interface 111 and input some basic criteria like a desired format, (i.e. country, rock) and a desired tempo (fast slow) and what kind of royalty arrangement he would like and a desired popularity level of the artist. The business modeling system 134 could review data in the data bases and based on weightings, rules and/or artificial intelligence routines can suggest composers and/or lyricists or even publishers and labels that provide a “best fit” for the shopping recording artist or a shopping label or publisher.

Thus, the data harvester 90 can also store data associated with the unique number associated with a title such as tempo, format, royalty arrangement, popularity, availability, and other data that describes an attribute that can e associated with the song or content. In addition business modeling system 134 could provide a “best” playlist for a touring artist or for a best of compact disk using the data available to the system. This content related information disclosed herein can also be utilized by media outlets to create or modify content programming.

While the aforementioned functions of the various network nodes are illustrated in FIG. 3 as separate workstations, those skilled in the art will appreciate that selected functions may be integrated into a single workstation, or a single function may be distributed across multiple nodes or processing platforms. Some nodes may also be connected by more direct means than the Internet, for example data harvester 90 may be co-located with databases or other data processing equipment such as network activity monitor 94. The arrangements of the present disclosure could also utilize communications systems other than the Internet, so the example of FIG. 3 should not be construed in a limiting sense regarding communication protocol, system configuration, node locations, connections or network infrastructure.

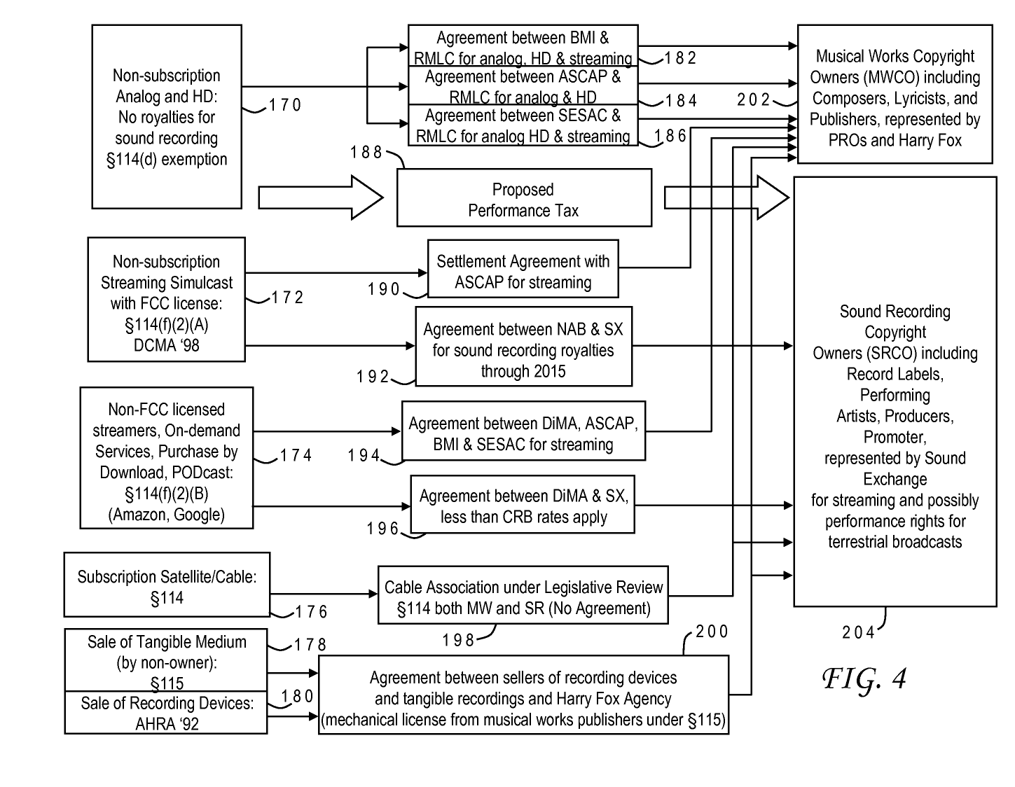

Referring to FIG. 4, a basic flow diagram is provided to depict the interrelationships between content distributors or media outlets and rights holders. It can be appreciated that there are loosely defined process and specific formulas that can be utilized to determine an appropriate compensation for specific rights holders. Thus, the disclosed royalty compensation system can operate based on a variety of relationships, private license arrangements, legislative or judicial mandates, or statutes in accordance with one implementation of the present disclosure.

Thus, for certain non-subscription analog and high definition (HD) terrestrial broadcasts or transmissions, no royalties are due for sound recording rights holders pursuant to the exemption of 17 U.S.C. §114(d), although there may be applicable private contracts or agreements between committees such as the radio music license committed (RMLC) and various PROs such as BMI, ASCAP and SESAC having various compensation arrangements as illustrated by private license agreements 182, 184, 186.

The agreements 182, 184, 186 can define payment relationships between content distribution and one or more rights holders such as musical works copyright owners (MWCOs) 202 which can for example include composers, lyricists, and publishers. Although not specifically shown, the MWCOs could be, and often are represented one or more PROs as noted in block 202. MWCOs 202 have proposed and are lobbying for a statutory royalty payment to the rights holders in the recording for recordings that are transmitted by terrestrial radio stations. This has been referred to as the “performance tax legislation” 188 whose legislation is under review by the legislature. If this legislation passes another entirely new media distribution-royalty compensation process will be implemented were sound recording copyright owners (SRCOs) 204 will be compensated by terrestrial radio stations for transmitting content.

One or more qualified media outlets that have a Federal Communications Commission (FCC) license, transmit terrestrially and perform non-subscription streaming simulcasts as in block 172 have a settlement agreement from past litigation where the qualified media outlet pays the MWCO 202 base on the intricate details of the settlement. Whereas, non-qualified media outlets that are defined under 17 U.S.C. §114(f)(2)(A) and under the Digital Millennium Copyright Act of 1998 (DMCA '98) will pay rates that are promulgated by the legislatively sanctioned Royalty Review Board (not shown). Qualified non-subscription services (via representation organization such as the National Association of Broadcasters (NAB), have negotiated a royalty rate with Sound Exchange, the judicially sanctioned PRO, for streaming simulcasts through 2015 as illustrated by block 192, to be paid to the SRCOs 204. For clarity, agreement 190 resulted from a settlement to litigation while the NAB/SX agreement 192 results from negations to meet a deadline for the parties to agree to a rate that was set by the legislature.

For media outlets that are non-FCC licensed streamers, and provide on-demand services, purchase-by-download, and/or POD casts as illustrated in block 174, the provisions of 17 U.S.C. §114(f)(2)(B) might apply. Those provisions allow for agreements such as agreement 194 negotiated by digital online media association (DiMA), who represent media outlets that do not have an FCC license and do not provide terrestrial broadcasts and PROs who represent MWCOs 202 such as ASCAP, BMI and SESAC as illustrated by block 194. In mid 2009, these streamers that do not provide terrestrial broadcasts 174 entered into an agreement with Sound Exchange where these Internet based music providers received royalty rates that are considerably less than the rates promulgated by the Copyright Royalty Board. These royalty rates are based on gross revenue receipts of the streaming entity and this royalty is due to the SRCOs via Sound Exchange.

In the absence of private agreements or settlements, such as an agreement between DiMA and Sound Exchange, the Copyright Royalty Board (CRB) royalty rates 196 would apply, which results in payments to SRCOs 204. For subscription satellite or cable transmissions 176, §114 or 17 U.S.C requires royalty payments by cable and satellite transmitters for both publisher rights or musical works and label rights or sound recordings according to legislation 198 that is currently under review by the legislature.

Entities who reproduce and sell a recording and do not own such rights (i.e. the reproduction and sale by a non-label rights owners) as illustrated by box 178, the law provides a compulsory license that can be purchased from the Harry Fox Agency under 17 U.S.C §115 as illustrated by block 200. As illustrated by block 180, entities who manufacture or sell recording devices are subject to the Audio Home Recording Act of 1992 (AHRA '92), and pay compensation according to various agreements 200 between sellers of recording devices and tangible recordings and Harry Fox Agency (including a mechanical license from musical works publishers under 17 U.S.C. §115). Those agreements result in payments to both MWCOs 202 and SRCOs 204.

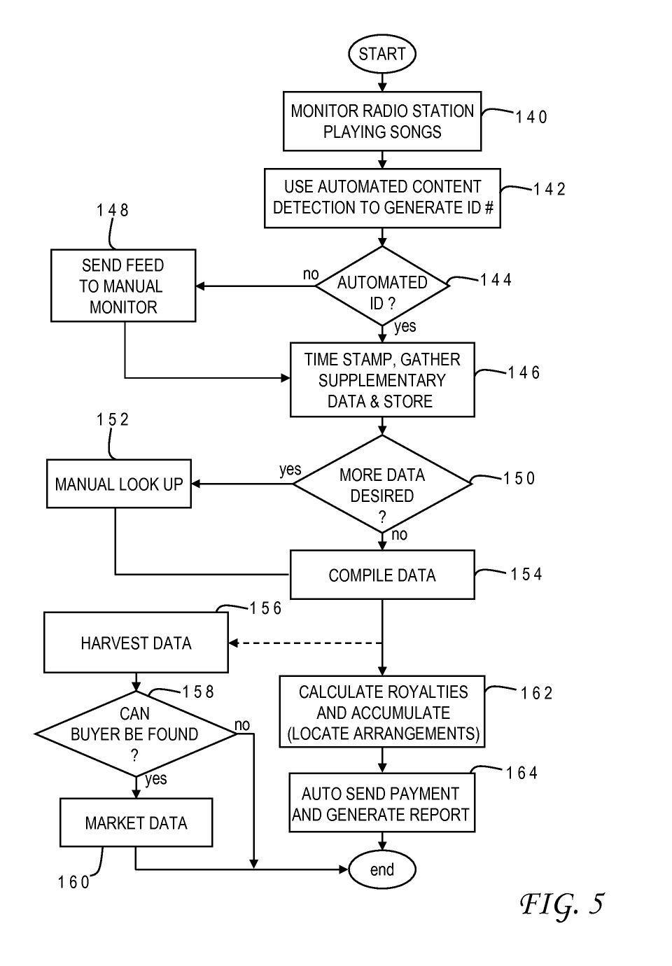

The present disclosure may be further understood with reference to the flow diagram of FIG. 5 which illustrates the logical flow for automated content distribution royalty reporting. The process begins when a broadcast media outlet such as a radio station or webcaster plays or distributes a song or other work to one or more end users such as a listener or an audience. The electronic transmission is monitored, (140) and automated content detection (142) can be invoked to generate a unique identification number that identifies the transmitted content. This process can utilize many different technologies such as watermarking and, voice and music detection algorithms.

As illustrated by decision block 144, it can be determined if the content can be identified and if it can its unique identifier can be associated with a time slot that the content was provided to listeners and then the system can search for supplementary data or associated data using the unique identifier. The UNS system described above could be utilized to provide the unique identifier. If the content cannot be identified then the monitoring data can be sent to a manual monitoring service as illustrated by block 148. The manual monitoring service can be implemented by a group of people who listen to at least a portion of the song and possibly look up a playlist from the content distributor and perform other research to positively identify the song and assign the unique identifier to the song. In the event that the song is a first case the manual monitoring system can assign a new number.

Once a unique identifier is available, data fields, that can provide more information about the distributed content, can be populated. As illustrated by block 146 the unique identifier can be time stamped according to when the content was distributed and then additional data can be gathered. The process can continue to access data bases possibly using cross referencing features for composition identifiers. The process can also gather supplemental data (metadata) from the available databases and store it with the content usage data. As illustrated by block (146), a determination can be made as to whether more data is still desired (150) in order to provide royalty compensation to rights holders in accordance with the law and private agreements. In some embodiments, the system can attempt to fill out a template having data fields where there are certain data fields that are required to complete the royalty compensation process. Inferences based on statutes and common industry practices can be used to fill in some of the empty data fields.

Data fields can include but are not limited to; rights holders, composer, lyricist, performer, publisher, label, sound recorder, PRO, identification codes, private royalty arrangements, statutory royalty arrangements, song popularity, and other data and metadata. If some of the desired data cannot be located automatically as illustrated by decision block 150, then a request for manual entry can be sent and a manual look up of the data can be performed (152). Once an appropriate amount of data is collected, it can be compiled by checking associations with rights owners and raw cost input data used to determine royalties or other fees for the given usage (154). The data at this juncture may optionally be harvested for statistical purposes, marketing purposes and business opportunity analysis (156). If a buyer for the data can be found (158), it is flagged for marketing to the proposed buyer (160). In any event, the compiled data is used to determine compensation due to any rights holders (162), after locating any applicable compensation arrangement based on the type of transmission (e.g., analog, streaming, satellite, cable, etc.). Compensation amounts may be accumulated according to the rights holders of the distributed musical composition. Corresponding reports and payments can be automatically sent (164) to the rights holders based on payment instruction acquired in previous steps.

Metadata for a given musical composition in the report may include indicators or parameters associated with payment terms, a performer, a publisher, a composer, a lyricist, a band, a reporting period, a media outlet, a record label, a number of times that an individual musical composition was played, a number of times that an individual musical composition was played on a specific media outlet, and a number of times that the individual composition played.

Although the disclosed arrangement s has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A computer-implemented method of managing a compensation system for rights holders, comprising:
monitoring an electronic transmission, the electronic transmission having a plurality of musical compositions;
acquiring a unique identifier associated with an individual musical composition of the plurality of musical compositions;
searching at least one relational database to locate information associated with the unique identifier, the information including a unique identity of a first rights holder in the individual musical composition and a unique identity of a second rights holder in the individual musical composition;
locating at least one compensation arrangement applicable to the first rights holder and the second rights holder based on a type of the electronic transmission;
determining a first compensation amount applicable to the first rights holder and a second compensation amount applicable to the second rights holder in response to the transmission of the individual musical composition utilizing the at least one compensation arrangement;
accumulating the determined first and second compensation amounts due the first and second rights holder according to the plurality of musical compositions; and
generating a compensation report having accumulated compensation amounts.

2. The method of claim 1 further comprising paying one of the accumulated compensation amounts to at least one of the first or second rights holder.

3. The method of claim 1 wherein said locating further comprises searching a database for the at least one compensation arrangement.

4. The method of claim 1 further comprising periodically querying third party databases and storing information related to unique identifiers locally.

5. The method of claim 1 wherein said searching further comprises searching via a computer network.

6. The method of claim 1 further comprising locating the relational database via the Internet.

7. The method of claim 1, further comprising including a title for the individual musical composition and metadata associated with the individual musical composition in the compensation report.

8. The method of claim 7, wherein the metadata includes indicators of payment terms, a performer, a publisher, a composer, a lyricist, a band, a reporting period, a media outlet, a record label, a number of times that an individual musical composition was played, a number of times that an individual musical composition was played on a specific media outlet, and a number of times that the individual composition played.

9. The method of claim 1 wherein the first rights holder has rights that are superior rights to rights of the second rights holder.

10. The method of claim 9 wherein the first rights holder is one of a record label or a publisher and the second rights holder is a collective organization.

11. The method of claim 9, further comprising reducing an amount of compensation due to the second rights holder based on an agreement between a media outlet of the electronic transmission and the first rights holder.

12. The method of claim 1, wherein said determining includes determining a per-content transmission rate regarding each individually transmitted musical composition transmitted.

13. The method of claim 1 further comprising deducting an amount from a fixed fee due to the second rights holder based on an agreement between a media outlet of the electronic transmission and the first rights holder.

14. The method of claim 1, further comprising utilizing search rules to search a plurality of databases to acquire data and metadata associated with the individual musical composition.

15. The method of claim 1 wherein the electronic transmission type is one of the Internet, a terrestrial broadcast, a high definition terrestrial broadcast, a cellular network, or a satellite transmission.

16. The method of claim 1, further comprising:
identifying an entity that facilitates at least part of the electronic transmission;
accessing data based on said identifying; and
determining a royalty liability of the entity using the data.

17. The method of claim 16, wherein the entity is one of a content distributor, a content provider, a service provider, a content mover, a middleman, an intermediary, a repeater, an aggregator, an encoder, a communications provider, a subscriber based distribution system, a portal provider, or an Internet service provider.

18. The method of claim 1 wherein data utilized to generate the compensation report is utilized to generate business planning data.

19. An automated reporting system for broadcast media, comprising:
a monitor which automatically examines content usage of an electronic transmission at a broadcast outlet to generate content usage data, wherein the electronic transmission includes a plurality of musical compositions, and the content usage data includes unique identifiers associated with individual musical compositions in the plurality of musical compositions;
a relational database which correlates the unique identifiers with at least one first rights holder and at least one second rights holder who are due compensation for portions of the electronic transmission at the broadcast outlet;
a royalty calculator which automatically locates a compensation arrangement applicable to the first rights holder and the second rights holder based on a type of the electronic transmission, and automatically calculates a first compensation amount applicable to the first rights holder and a second compensation amount applicable to the second rights holder based on the compensation arrangement; and
a reporter which automatically generates a compensation report including the first and second compensation amounts.

20. A computer-implemented method of managing a compensation system for broadcast media, comprising:
receiving content usage data from one or more monitors which examine content usage of media output at one or more broadcast outlets;
correlating the content usage data with at least one superior rights holder and at least one inferior rights holder who are due compensation for portions of the media output at the one or more broadcast outlets, wherein the superior rights holder is due less compensation that the inferior rights holder for the content usage and payment to the superior rights holder for the content usage eliminates or reduces compensation due to the inferior rights holder;
calculating a payment amount for the compensation due to the superior rights holder for the content usage and a deduction amount for the compensation due to the inferior rights holder based on the payment amount; and
storing the payment and deduction amounts in association with the superior and inferior rights holders and the content usage data.
